(19) United States
(12) Patent Application Publication
(10) Pub. No.: US 2026/0348503 A1
(43) Pub. Date: Nov. 5, 2026

(54) Steel-Core CPVC Seismic Brace Coupling

(71) Applicant: Justin Hegle, South Gate, CA (US)

(72) Inventor: Justin Hegle, South Gate, CA (US)

(21) Appl. No.: 19/659,755

(22) Filed: Apr. 27, 2026

(30) Foreign Application Priority Data
May 4, 2025 (US) 63/799654
Jun. 9, 2025 (US) 63/799654

(51) Int. Cl. F16L 47/02; F16L 9/12

(52) U.S. Cl. CPC F16L 47/02; F16L 9/12

(57) ABSTRACT

A coupling assembly 10 enabling CPVC fire sprinkler piping to be seismically braced using standard listed steel seismic bracing hardware. The assembly includes a steel tubular core 12 with CPVC sockets 14, 16 joined by a bonding layer 18. Optional mechanical interlock features 20 enhance bonding. An optional internal lining 22 maintains CPVC hydraulic performance. The steel core 12 provides a braceable surface for transverse brace clamps 30 and longitudinal brace clamps 32, enabling full seismic bracing compatibility for CPVC systems.

### CROSS-REFERENCE TO RELATED APPLICATIONS

This application claims the benefit of U.S. Provisional Patent Application No. 63/799,654, filed [May 4, 2025], and U.S. Provisional Patent Application No. 63/820,317, filed [Jun. 9, 2025], the entire contents of which are hereby incorporated by reference.

### FIELD OF THE INVENTION

This invention relates to fire protection piping systems, specifically CPVC fire sprinkler piping installed under NFPA 13, 13R, and 13D. It concerns seismic bracing, restraint, and support of CPVC piping using standard metallic seismic bracing hardware by introducing a braceable steel core section integrated into CPVC piping.

### BACKGROUND OF THE INVENTION

CPVC fire sprinkler piping is widely used due to its corrosion resistance, light weight, and ease of installation. However, CPVC has significant limitations in seismic bracing:
CPVC cannot be clamped directly with standard steel seismic bracing hardware (e.g., Tolco FIGS. 1000, 1001, 4L, 4S).
CPVC requires specialized, expensive, proprietary CPVC-rated bracing hardware such as Tolco FIG. 3000.
No listed longitudinal seismic brace exists for CPVC piping.
CPVC cannot be directly bonded to metal using standard solvent cements.
CPVC friction loss (C=150) differs from steel (C=120), creating hydraulic penalties if steel sections are introduced.

There is a need for a universal, code-acceptable method to introduce a braceable steel section into CPVC piping without compromising hydraulic performance, structural integrity, or listing requirements.

### SUMMARY OF THE INVENTION

The invention provides a steel-core coupling assembly that allows CPVC piping to be braced using ordinary listed steel seismic bracing hardware. The assembly consists of:
A steel pipe nipple or tubular steel section (“steel core”).
A CPVC slip-on coupling or socket at each end.
A bonding, joining, or integration method that permanently unites the CPVC ends to the steel core.

Bonding methods include adhesive bonding, injection molding, overmolding, mechanical interlock, thermal bonding, chemical bonding, or any industry-standard metal-to-plastic joining method.

Optional embodiments include internal hydraulic-equivalent coatings applied to the steel core interior to maintain a friction factor equivalent to CPVC (C=150), such as CPVC lining, epoxy, polymer coatings, or inserted CPVC sleeves.

The steel core provides a braceable metallic surface enabling transverse, longitudinal, and sway bracing using standard listed steel hardware.

### BRIEF DESCRIPTION OF THE DRAWINGS

FIG. 1

Perspective view of the Steel-Core CPVC Seismic Brace Coupling 10, showing the steel tubular core 12 and CPVC sockets 14, 16.

FIG. 2

Longitudinal cross-sectional view showing the steel core 12, CPVC sockets 14, 16, bonding layer 18, and optional internal hydraulic-equivalent lining 22.

FIG. 3

Exploded view showing the steel core 12, CPVC sockets 14, 16, and bonding layer 18 separated to illustrate assembly and bonding options.

FIG. 4

Mechanical interlock embodiment showing grooves, knurling, perforations, or undercuts 20 on the steel core 12 to enhance bonding.

FIG. 5

Injection-molded or overmolded embodiment where CPVC sockets 14, 16 are molded directly onto the steel core 12.

FIG. 6

Transverse seismic brace installation showing a standard steel brace clamp 30 attached to the steel core 12, with brace member 34 extending to the structure.

FIG. 7

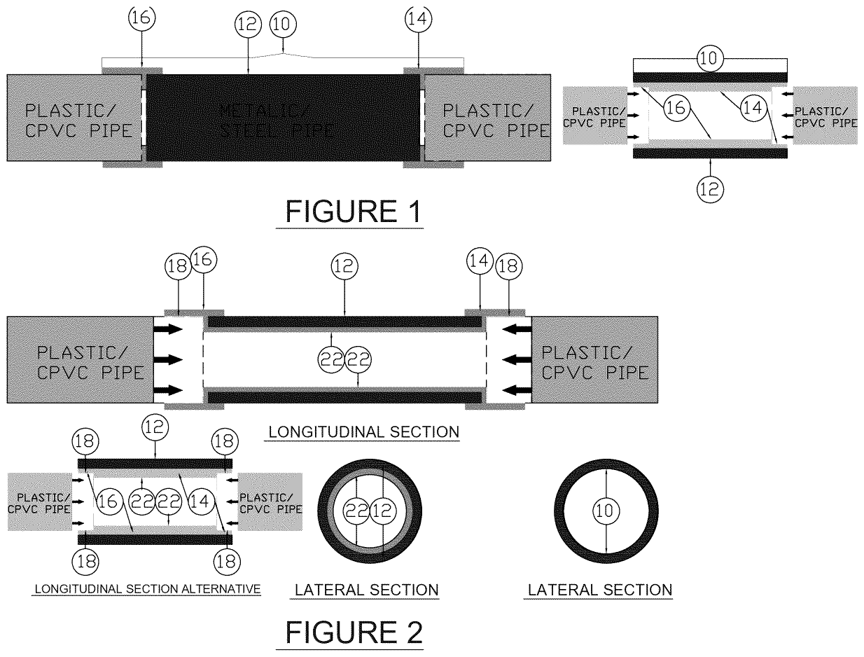

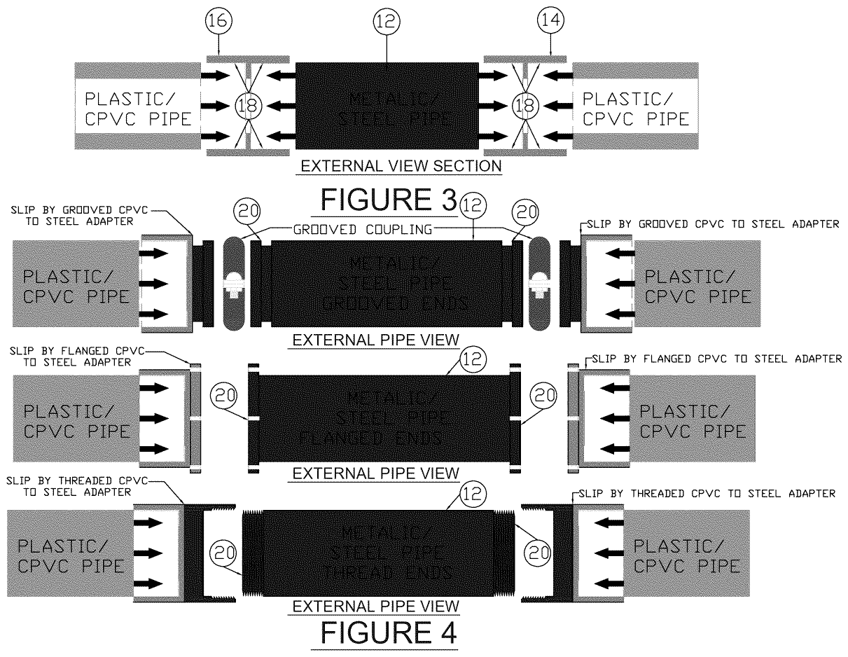

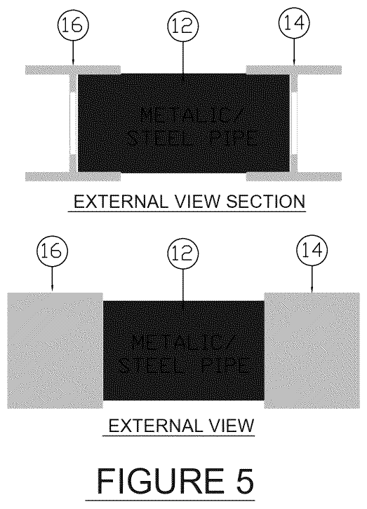

Longitudinal seismic brace installation showing a longitudinal brace clamp 32 attached to the steel core 12, with brace member 34 extending to the structure.

### DETAILED DESCRIPTION OF THE INVENTION

### 1. Steel Core Section

The steel core 12 is a steel pipe nipple or tubular steel section between 3″ and 24″ in length. It may be Schedule 10, 40, or 80 steel, galvanized or black steel, stainless steel, or any metallic material listed for seismic bracing clamps. The steel core provides a braceable surface compatible with all listed steel seismic bracing hardware.

### 2. CPVC End Connections

Each end of the steel core 12 is fitted with a CPVC slip-on coupling or socket 14, 16. These may be standard CPVC fittings, custom overmolded sockets, or CPVC sleeves bonded to the steel core.

### 3. Bonding/Joining Methods

The bonding layer 18 may be formed by:
Adhesive bonding
Injection molding
Overmolding
Thermal bonding
Mechanical interlock features 20
Chemical bonding
Hybrid bonding methods

### 4. Hydraulic-Equivalent Internal Coating

The interior of the steel core 12 may include an internal lining 22 made of CPVC resin, epoxy, polymer, or a CPVC sleeve to maintain a friction factor equivalent to CPVC (C≈150).

### 5. Seismic Bracing Compatibility

The steel core 12 allows attachment of:
Transverse brace clamps 30
Longitudinal brace clamps 32
Brace members 34

This enables full seismic bracing compatibility for CPVC systems, including the first practical method for longitudinal bracing.

1. A coupling assembly 10 for CPVC fire sprinkler piping comprising a steel tubular section 12, CPVC sockets 14, 16 at each end, and a bonding layer 18 permanently uniting the CPVC sockets to the steel tubular section, wherein the steel tubular section provides a braceable metallic surface compatible with listed steel seismic bracing hardware.

2. The assembly of claim 1, wherein the bonding layer 18 comprises adhesive bonding, mechanical interlock 20, overmolding, injection molding, thermal bonding, chemical bonding, or any combination thereof.

3. The assembly of claim 1, wherein the interior of the steel tubular section 12 includes an internal lining 22 having a Hazen-Williams C-factor of approximately 150.

4. The assembly of claim 1, wherein the steel tubular section 12 is between 2″ and 48″ in length.

5. The assembly of claim 1, wherein the steel tubular section 12 is galvanized steel, black steel, stainless steel, or any metallic material listed for seismic bracing.

6. The assembly of claim 1, wherein the CPVC sockets 14, 16 are standard CPVC fittings.

7. The assembly of claim 1, wherein the CPVC sockets 14, 16 are molded directly onto the steel tubular section 12.

8. The assembly of claim 1, wherein the bonding layer 18 comprises a CPVC-compatible structural adhesive.

9. The assembly of claim 1, wherein the steel tubular section 12 includes mechanical interlock features 20.

10. The assembly of claim 3, wherein the internal lining 22 comprises CPVC resin, epoxy, polymer lining, or a CPVC sleeve.
